(19) United States
(12) Patent Application Publication
(10) Pub. No.: US 2026/0116800 A1
(43) Pub. Date: Apr. 30, 2026

(54) METHOD FOR REMOVAL OF NITRATE FROM WASTEWATER EFFLUENT

(71) Applicant: James John Peterson, San Diego, CA (US)

(72) Inventor: James John Peterson, San Diego, CA (US)

(21) Appl. No.: 19/370,105

(22) Filed: Oct. 27, 2025

Related U.S. Application Data
(60) Provisional application No. 63/712,196, filed on Oct. 25, 2024.

(51) Int. Cl. C02F 9/00; C02F 1/44; C02F 1/52; C02F 3/30; C02F 101/10

(52) U.S. Cl. CPC C02F 9/00; C02F 1/441; C02F 1/444; C02F 1/5245; C02F 3/303; C02F 2101/105; C02F 2301/043

(57) ABSTRACT

A method is disclosed for improving nitrate removal of a wastewater treatment plant. The method includes treating secondary effluent of the wastewater treatment plant to post nitrification and ultrafiltration prior to splitting the resultant into a feed stream and a bypass stream. The feed stream is fed into a high-pressure membrane treatment process while the bypass stream bypasses the high-pressure membrane treatment process. A permeate and a brine are output from the high-pressure membrane treatment process, thereafter the permeate is blended with the bypass stream, while the brine is fed back to the raw influent of the wastewater treatment plant to enhance an anoxic volume integrated into the wastewater treatment plant.

### CROSS REFERENCE TO RELATED APPLICATION

This application claims the benefit of priority of U.S. provisional application No. 63/712,196, filed Oct. 25, 2024, the contents of which are herein incorporated by reference.

### BACKGROUND OF THE SUBJECT DISCLOSURE

The present subject disclosure relates to denitrification wastewater treatment processes and, more particularly, to a method for removing nitrate from wastewater effluent that reduces capital infrastructure cost.

Nitrate contamination in wastewater effluent is a significant environmental and public health concern. When released into water bodies, nitrate causes eutrophication, where excessive nutrient levels promote algae blooms that block sunlight and deplete oxygen. This leads to hypoxic conditions, resulting in dead zones that harm aquatic ecosystems and decrease biodiversity. The disruption affects aquatic life and industries dependent on these ecosystems, such as fishing and recreation.

Nitrates in drinking water also pose serious health risks. High concentrations can lead to methemoglobinemia (blue baby syndrome) in infants, inhibiting oxygen transport in the blood. Long-term exposure may increase the risk of certain cancers and other health issues. To prevent such risks, many countries have set regulatory limits on nitrate levels in wastewater discharge, requiring treatment plants to adhere to these standards.

To protect ecosystems and human health, effective nitrate removal from wastewater is crucial. Treatment methods like biological denitrification, ion exchange, and reverse osmosis help reduce nitrate levels in effluent, ensuring compliance with environmental regulations and safeguarding water quality. However, as standards become more stringent, enhancing nitrate removal of pre-existing treatment plants instead of building new treatment plants from scratch are increasingly necessary for making sustainable wastewater management economical and politically feasible.

An anoxic zone is a crucial step in wastewater treatment that plays a vital role in removing nitrogen; specifically, the anoxic zone is an environment where there is no dissolved oxygen but still other electron acceptors present, such as nitrate. The anoxic zone facilitates the process of denitrification, where bacteria convert nitrate (NO3-) into nitrogen gas (N2). This process is achieved by, in short, bacteria using nitrate as an electron acceptor for respiration, whereby nitrate is reduced to nitrogen gas, which is released into the atmosphere, removing nitrogen from wastewater. The anoxic zone is typically embodied in a tank or basin designed to exclude oxygen but still allows for mixing, where wastewater is introduced into the zone, along with a source of carbon (e.g., raw wastewater, methanol or ethanol) to provide an electron donor for the denitrifying bacteria. The tank is maintained at anoxic conditions by monitoring and adjusting oxygen levels and carbon sources.

Currently nitrate concentrations are typically not effectively removed from effluent during today's high pressure membrane treatment (PMT) processes because the resulting brine that is disposed of as a liquid waste is a nitrate concentrated media. For wastewater treatment plants that incorporate PMT processes, including but not limited to reverse osmosis (RO) and nanofiltration (NF), in their effluent treatment, the PMT process concentrates nitrate and other dissolved substances into this brine byproduct, while separately producing desire permeate. RO works by forcing water through a semi-permeable membrane, which removes contaminants, including nitrates, from the treated water. Wastewater treatment reverse osmosis brine is the concentrated, salty by-product left over after RO membranes remove contaminants from water. Managing this brine is a key challenge, and common treatment and disposal methods include evaporation ponds, thermal evaporation, deep well injection, discharge into the sea, or using technologies like membrane distillation to further concentrate or recover resources from the brine. However, the pollutants do not disappear; instead, they are retained and concentrated in the brine. This RO brine contains significantly higher concentrations of nitrate compared to the original effluent.

In existing activated sludge systems, total nitrogen removal occurs through sequential nitrification and denitrification. Ammonia is first oxidized to nitrate under aerobic conditions, and nitrate is then reduced to nitrogen gas under anoxic conditions using organic carbon. An internal recirculation loop, typically 200 to 500% of the influent flow, transfers nitrate-rich liquor from the aerobic zone to the anoxic zone to enable denitrification. The recirculation rate strongly influences nitrogen removal efficiency too low limits nitrate supply, while too high increases oxygen carryover and energy use.

To avoid costly retrofit of existing infrastructure, it is appealing to add skid mounted equipment on grade that can remove total nitrogen. One barrier to this approach is the ability of the clarifier 40 to manage the impact of the high 200% to 500% recycled flows that occur as described earlier, since the clarifier solids removal capacity is a function of flow or hydraulic loading rate typically ranging from 200 to 1500 gpd/ft2.

Using a post-nitrification process in conjunction with production of a high concentration brine, concentrates the return nitrate, which in turn reduces the recycled flows that typically range from 200% to 500% to less than 50%, avoiding the need for more expensive retrofit such as a membrane bioreactor or additional installed clarification capacity.

Producing a concentrated brine has the additional benefit of optional brine extraction from the system, if another desired result is the reduction of total dissolved solids (TDS).

As can be seen, there is a need for a method for enhancing nitrate removal from wastewater effluent through producing and reincorporating the PMT brine back into an upstream anoxic treatment process in a way that reduces the concentration of nitrate discharged by the treatment plant, also reducing the oxygen demand of the wastewater. The synergetic decrease in oxygen demand is realized during the anoxic treatment process, as the reduction of nitrate is coupled with the oxidation of organic matter, thereby effectively satisfying a portion of the wastewater's carbonaceous oxygen demand (BOD) and releasing it as harmless nitrogen gas.

### SUMMARY OF THE SUBJECT DISCLOSURE

The subject disclosure is geared for pre-existing treatment plants that cannot effectively remove nitrate from their wastewater discharge to meet regulatory limits and/or otherwise desire to cost-effectively improve their operational performance using existing equipment with minimal additional cost or equipment.

The method embodied in the subject disclosure feeds nitrate-rich brine resulting from both, in sequence, post nitrification of a wastewater treatment plant's secondary effluent and immediately followed by one or more pressurized membrane treatment (PMT) processes that results in the nitrate-rich brine (or “PMT brine”). The PMT brine is redirected and mixed back into the influent stream at the head of the wastewater treatment plant (see FIGS. 2 and 3). This PMT brine and influent mixture enters an anoxic zone of the wastewater treatment plant. The anoxic zone may be added to pre-existing plants or already be present.

Recycling PMT brine back to the anoxic zone of the treatment enhances the mass of nitrate removed through denitrification during this anoxic component of the treatment process since the PMT brine is a low volume, high concentration format that enhances denitrification while, relatively, adding little volume. Concentrating the nitrate in the brine eliminates the need for costly retrofits of existing infrastructure through additional clarifiers or conversion to a membrane bioreactor. In the anoxic environment, bacteria convert these concentrated nitrates into nitrogen gas, which is released into the atmosphere. This recycling approach not only helps reduce the overall nitrate levels in the wastewater discharge (by returning the nitrate-rich PMT brine upstream) but also makes efficient use of the concentrated nitrate of the PMT brine to enhance the anoxic zone, thereby leveraging biological processes, via this return component, for enhancing removal of nitrate during wastewater treatment. In sum, the influent-PMT brine mixture reduces the concentration of nitrate and reduces the portion of oxygen demand of the treatment process exerted by organic material through anoxic respiration.

By installing post-nitrification equipment directly feeding into PMT processing to feedback the resulting PMT brine in future iterations of the denitrification process, it enables improvement of pre-existing treatment plants to increase the effectiveness of nitrate removal using existing tank and clarifier infrastructure, while reducing the nitrate load in their final discharge. Thereby, recycling and integration of PMT brine helps meet stringent environmental regulations, while also improving the efficiency and sustainability of a treatment plant's overall nitrate removal system.

Recycling PMT brine for denitrification is a resource-efficient approach that leverages the treatment process's existing biology to enhance the anoxic zone, where naturally denitrifying bacteria converts nitrates into nitrogen gas without additional chemicals or energy, and in turn makes the method of the subject disclosure a sustainable and low-maintenance solution for nitrate removal.

It is understood that PMT processing includes reverse osmosis (RO) processing, nanofiltration (NF) processing, and/or other processes know or developed in the future which concentrate the input's nitrate into brine as well as results in desired permeate.

In one aspect of the subject disclosure a method of improving a wastewater treatment process comprising an aerobic volume and a clarifier between a raw influent and a secondary effluent, the method including: separating the secondary effluent into a pressurized membrane treatment (PMT) feed stream and a bypass stream, wherein the PMT feed stream is processed by a PMT component downstream of the secondary effluent, wherein the PMT component outputs a brine stream and a permeate stream; feeding the brine stream back to the raw influent; and routing the bypass stream to bypasses said PMT component and merge with the permeate stream, wherein an anoxic volume is disposed between the influent and the aerobic volume, routing the secondary effluent directly to a post-nitrification process prior to separation into the PMT feed stream and the bypass stream, wherein the post-nitrification process comprises a ultrafiltration process, further including chemically removing phosphorous from the secondary effluent prior to the ultrafiltration process, wherein the chemical removal of phosphorous includes adding a coagulant, wherein the coagulant is ferric chloride, operating the bypass stream in a range of ten to sixty percent of the raw influent, further including directing a fraction of the brine stream to a waste disposal to reduce a dissolved solids concentration of a final wastewater effluent.

In another aspect of the subject disclosure a system for treating wastewater includes an anoxic volume configured to receive a mixture of influent; an aerobic volume directly downstream of the anoxic volume, wherein the aerobic volume is configured to discharge a secondary effluent; a nitrification unit configured to receive the secondary effluent, wherein the nitration unit is configured to output a pressurized membrane treatment (PMT) feed stream and a bypass stream; and a PMT unit directly downstream of the PMT feed stream, wherein the PMT unit is configured to output a brine stream and a permeate stream, wherein the brine stream is mixed with said mixture of influent, and wherein the bypass stream is blended with the permeate stream, wherein the nitrification unit comprises a ultrafiltration element, wherein the PMT unit comprises a reverse osmosis component, wherein the PMT unit comprises a nanofiltration component, wherein a clarifier is operatively associated with the anoxic volume, wherein the nitrification unit comprises a ultrafiltration process, further including a removal unit configured to chemically remove phosphorous from the secondary effluent prior to the ultrafiltration process, wherein the chemical removal of phosphorous includes adding a coagulant, wherein the coagulant is ferric chloride

These and other features, aspects and advantages of the present subject disclosure will become better understood with reference to the following drawings, description and claims.

### BRIEF DESCRIPTION OF THE DRAWINGS

FIG. 1 is a schematic view of an exemplary embodiment of an existing wastewater treatment process that incorporates only an aerobic volume 30 and thus cannot perform total nitrogen reduction through a dedicated anoxic volume fraction.

FIG. 2 is a schematic view of an exemplary embodiment of the subject disclosure, where additional equipment has been installed to treat the secondary effluent 50 of the existing plant 20 through post nitrification and membrane filtration processes 60, followed by high pressure membrane treatment (PMT) processes 70, such as reverse osmosis, to produce a concentrated nitrate-rich brine 75. This PMT brine, containing high concentrations of salts and nitrate, is returned to mix with the influent 10 prior to entering a new anoxic volume 25 within the boundary of the existing plant 20 previously occupied as entirely aerobic volume 30, as shown in FIG. 1. A portion of the previous aerobic volume 30 may be separated to be the anoxic volume 25, resulting in a smaller aerobic volume 30 to maintain the same footprint as the pre-existing treatment plant 20. Downstream flow is proportionally bypassed in parallel to the PMT process component 70 to maintain a consistent dissolved solids concentration within the anoxic basin and prevent dissolved solids from accumulating in the system.

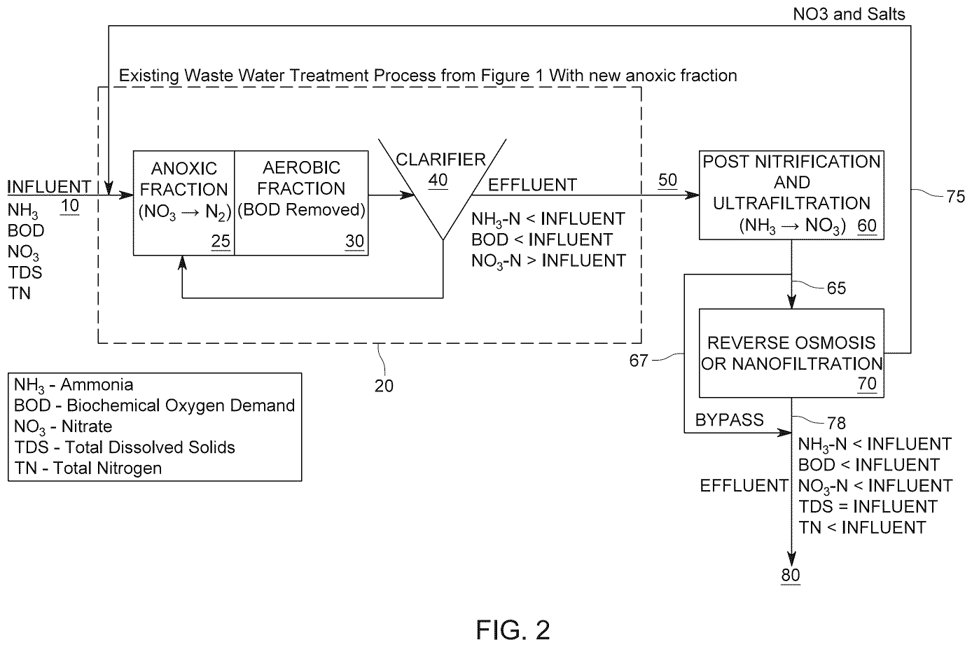

FIG. 3. is a schematic view of an exemplary embodiment of the subject disclosure that includes a mass balance to demonstrate an example within the potential range of concentrations that may occur at multiple steps in the process. Initially, the influent 10 contains a certain flow and concentration of ammonia and TDS with low nitrate concentration. Influent 10 is rapidly mixed with the PMT brine 75 to create a consistent combined stream 15 with higher flow, TDS and nitrate. This combined (PMT brine 75/influent 10) stream 15 is suitable for denitrification since the high nitrate return mixes with the carbon source (BOD) in the influent under anoxic conditions in the presence of heterotrophic bacteria, capable of performing biological denitrification. The effluent from the existing wastewater treatment plant (WWTP) 20, known as secondary effluent 50, is now low in nitrate and approximately equal in ammonia and TDS to the blended feed stream. Through addition of new equipment, the ammonia is converted to nitrate through high-rate nitrification, and the effluent 50 passes through ultrafiltration or microfiltration as described in U.S. patent application U.S. Ser. No. 18/662,568, also the work of the inventor, which is incorporated by reference herein. Effluent of the new nitrification and filtration system is split into a PMT feed stream 65 and a bypass stream 67. The bypass stream 67 bypasses the PMT component 70 to prevent accumulation of total dissolved solids (TDS) within the upstream process to manage impact of BOD removal and nitrification. Increasing TDS affects activated sludge performance differently for BOD removal (which maintains >90% efficiency below 5 g/L TDS) versus nitrification (which shows inhibition starting at 1-5 g/L and failure above 10-20 g/L), but acclimation strategies can improve tolerance. PMT permeate 78 is low in all dissolved constituents and blended with the higher concentration bypass flow to rebalance the concentrations to match the influent TDS of 1000 mg/L as in the case of FIG. 3.

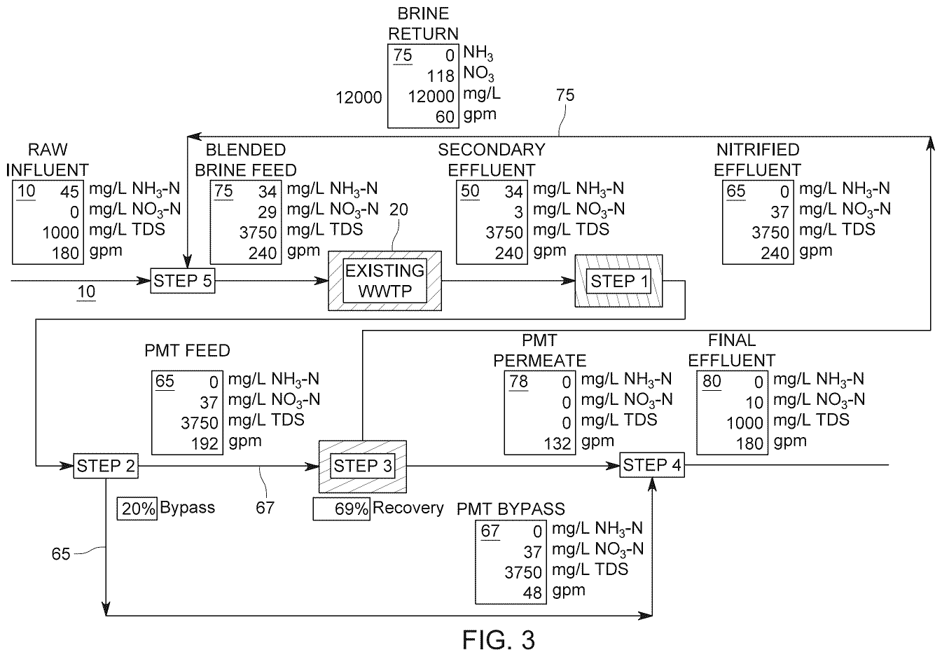

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, an embodiment of the subject disclosure provides a method for enhancing removing nitrate from wastewater containing an influent TDS in the range of 200 mg/L to 2000 mg/L and total nitrogen levels between 20 mg/L and 80 mg/L, effluent through feeding downstream nitrate-rich brine back to an upstream systemic anoxic zone to enhance the denitrification thereof, thereby improving the effluent water quality and treatment process efficiency through reduction of oxygen demand.

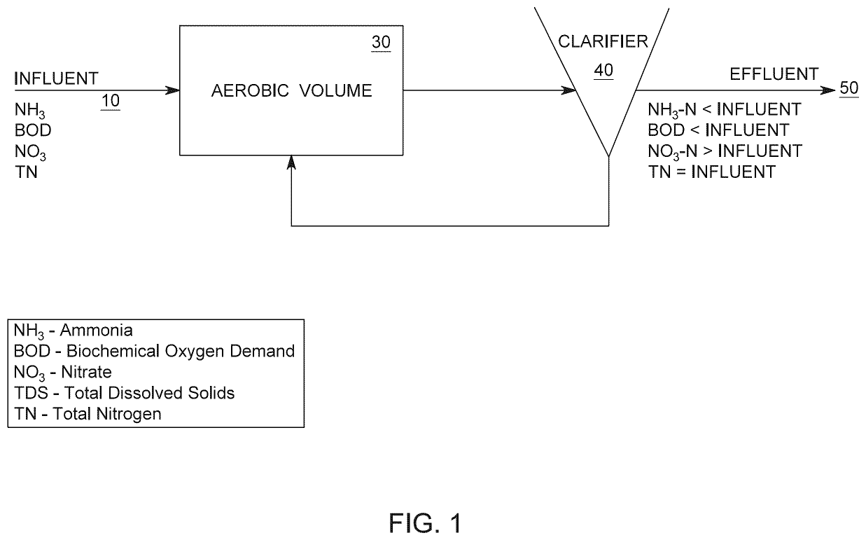

Referring to FIG. 1, the treatment process may include the following steps:

Step 1 provides for nitrification and pretreatment of existing wastewater effluent, containing ammonia for high pressure membrane treatment (PMT) processes (including but not limited to reverse osmosis (RO) and nanofiltration (NF)). The nitrification and pretreatment of Step 1 include biological nitrification and low-pressure membrane filtration such as ultrafiltration. Typical ranges of influent ammonia at the influent of step 1 range from 5 to 60 mg/L-N, with nitrate levels ranging from 1 mg/L to 20 mg/L measured as nitrogen. Total dissolved solids will operate between 500 mg/L and 10,000 mg/L measured as calcium carbonate. The effluent from step 1 will have similar flow and TDS levels to the influent, however the ammonia concentration will be between 0 mg/L and 10 mg/L and the nitrate concentration will be between 5 mg/l and 60 mg/L

Step 2, the resultant effluent of Step 1 is split into two streams consisting of a PMT feed stream and a bypass stream.

Step 3 includes PMT processing of the PMT feed stream. The feed to Step 3 will be equivalent in TDS, NO3 and NH3 to the effluent of Step 1. The permeate stream of the PMT Step 3 will have between 0 mg/L and 10 mg/L of ammonia and 0 mg/l and 10 mg/l of nitrate. The concentrated PMT brine will have a TDS concentration of between 5,000 mg/L and 25,000 mg/L.

Step 4 includes blending of PMT permeate from Step 3 with bypass stream from Step 2. The final blended TDS will be within the same range as the original influent TDS equivalent to between 500 mg/l and 2000 mg/L with total nitrogen levels lower than the influent of between 3 mg/L and 20 mg/L as nitrogen. Step 5 returns PMT brine generated from Step 3 to mix with and be fed back into the raw wastewater feed input/influent of the treatment process. The resultant operating TDS range of the new wastewater process is between 500 mg/L and 10,000 mg/L expressed as calcium carbonate.

The additional capacity provided in the pretreatment system (Step 1) enables a higher ammonia and suspended solids concentration effluent from the wastewater treatment plant. This may occur as the return of PMT brine (Step 5) results in carryover of solids due to the elevated TDS concentration and recycling flow or incomplete nitrification. Note, the plant may have existing capacity to absorb the volume that will be occupied through the new anoxic zone. However, if not, that capacity will be shifted to the post treatment (Step 1) process.

Control of bypass flow (Step 2) allows dissolved solids to pass the PMT process to control the upstream wastewater treatment plant dissolved solids concentration. Blending the bypass stream with the PMT permeate (Step 4) ensures that the effluent dissolved solids are in close approximation to the influent and to manage the operating TDS concentration in the wastewater process. It is known that TDS levels impact removal rates of BOD and ammonia. Increasing TDS affects activated sludge performance differently for BOD removal (which maintains >90% efficiency below 5 g/L TDS) versus nitrification (which shows inhibition starting at 1-5 g/L and failure above 10-20 g/L), but acclimation strategies can improve tolerance.

Acclimation procedures such as gradual TDS increases, phased acclimatization, and the incorporation of halotolerant or halophilic strains can help improve removal rates under higher TDS conditions.

Step 1 nitrification and PMT pretreatment adds oxidation and solids removal capacity and allows for the upstream wastewater plant to operate at a higher dissolved solids concentration (via the PMT brine) and with more anoxic volume for denitrification. The stream leaving the pretreatment component (Step 1) has been completely nitrified and thus all nitrogen may be separated using reverse osmosis. By ‘completely nitrified’ it is understood that approximately 95% or more of ammonia has been converted to NO3 or NO2.

Although concentrating and recycling nitrate upstream to the systemic anoxic volume has the benefits and advantages disclosed herein, there are potential process concerns that must be managed including plant hydraulic capacity, clarifier performance, process performance at elevated TDS, and corrosion of plant materials.

The key parameters to control in order to manage the process within the balance of total nitrogen removal and process efficiency relies on the daily volume and concentration of brine that is generated in Step 3 and returned in Step 5 as well as the ratio of PMT bypass stream that is performed in Steps 2 and 4. Higher brine concentrations and higher flows may negatively affect the settling characteristics of the activated sludge. Larger anoxic volumes within the plant may reduce the amount of volume available for nitrification, which can be compensated for using new post nitrification capacity installed on the effluent (Step 1).

Using a PMT system properly pretreated for ammonia and solids facilitates redirection of PMT brine containing high concentrations of nitrate to mix with the influent of the plant. Also creating a bypass line from the pretreatment system or upstream of the pretreatment system that bypasses the reverse osmosis system is critical. Typically, operating the bypass stream in a range of 10% to 60% of plant flow has been found to be decisive. Chemical pretreatment for removal of phosphorous could be incorporated by adding a coagulant such as ferric chloride prior to the ultrafiltration system in Step 1. A fraction of the PMT brine could be redirected to waste disposal to reduce the dissolved solids concentration of the final wastewater effluent.

A method of improving a pre-existing treatment plant, envisioned by the subject disclosure, includes configuring the bypass stream and brine return stream, and then operating the reverse osmosis system at 50% to 90% recovery and return all brine to headworks of the treatment system. For instance, recovery is the percentage of water that passes the membrane or is treated; thus, 10 gallon per minute (gpm) feed and 8 gpm permeate is an 80% recovery with 20% brine reject. Adjusting the bypass stream to achieve an operating total dissolved solids level that is acceptable for the pretreatment system to produce a water quality suitable for the reverse osmosis system and with acceptable kinetic rates for the activated sludge process to operate within a reasonable cleaning interval, membrane life, chemical and power consumption and BOD and nitrate removal. Process variables such as oxygen input into the original process, additional oxygen input into pretreatment process (Step 1), brine return flow and bypass flow can be adjusted to optimize wastewater treatment plant for energy and effluent quality depending on performance goals.

As a result, the method could be used to provide water that has been pretreated for potable or non-potable reuse or also live stream discharge or instream flows. Additionally, the process embodied by the subject disclosure could be controlled and optimized using artificial intelligence.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A method of improving a wastewater treatment process comprising an aerobic volume and a clarifier between a raw influent and a secondary effluent, the method comprising:
separating the secondary effluent into a pressurized membrane treatment (PMT) feed stream and a bypass stream, wherein the PMT feed stream is processed by a PMT component downstream of the secondary effluent, wherein the PMT component outputs a brine stream and a permeate stream;
feeding the brine stream back to the raw influent; and
routing the bypass stream to bypasses said PMT component and merge with the permeate stream.

2. The method of claim 1, wherein an anoxic volume is disposed between the influent and the aerobic volume.

3. The method of claim 2, routing the secondary effluent directly to a post-nitrification process prior to separation into the PMT feed stream and the bypass stream.

4. The method of claim 3, wherein the post-nitrification process comprises a ultrafiltration process.

5. The method of claim 4, further including chemically removing phosphorous from the secondary effluent prior to the ultrafiltration process.

6. The method of claim 5, wherein the chemical removal of phosphorous includes adding a coagulant.

7. The method of claim 6, wherein the coagulant is ferric chloride.

8. The method of claim 3, operating the bypass stream in a range of ten to sixty percent of the raw influent.

9. The method of claim 4, further comprising directing a fraction of the brine stream to a waste disposal to reduce a dissolved solids concentration of a final wastewater effluent.

10. A system for treating wastewater, the system comprising:
an anoxic volume configured to receive a mixture of influent;
an aerobic volume directly downstream of the anoxic volume, wherein the aerobic volume is configured to discharge a secondary effluent;
a nitrification unit configured to receive the secondary effluent, wherein the nitration unit is configured to output a pressurized membrane treatment (PMT) feed stream and a bypass stream; and
a PMT unit directly downstream of the PMT feed stream, wherein the PMT unit is configured to output a brine stream and a permeate stream,
wherein the brine stream is mixed with said mixture of influent, and
wherein the bypass stream is blended with the permeate stream.

11. The system of claim 10, wherein the nitrification unit comprises a ultrafiltration element.

12. The system of claim 10, wherein the PMT unit comprises a reverse osmosis component.

13. The system of claim 10, wherein the PMT unit comprises a nanofiltration component.

14. The system of claim 10, wherein a clarifier is operatively associated with the anoxic volume.

15. The system of claim 10, wherein the nitrification unit comprises a ultrafiltration process.

16. The system of claim 15, further comprises a removal unit configured to chemically remove phosphorous from the secondary effluent prior to the ultrafiltration process.

17. The system of claim 16, wherein the chemical removal of phosphorous includes adding a coagulant.

18. The system of claim 17, wherein the coagulant is ferric chloride.
